(19) United States
(12) Patent Application Publication
(10) Pub. No.: US 2005/0204118 A1
(43) Pub. Date: Sep. 15, 2005

(54) Method for inter-cluster communication that employs register permutation

(75) Inventors: Chein-Wei Jen, Hsinchu (TW); Tay-Jyi Lin, Hsinchu (TW); Chen-Chia Lee, Hsinchu (TW); Chin-Chi Chang, Hsinchu (TW); Chih-Wei Liu, Hsinchu (TW)

Correspondence Address: TROXELL LAW OFFICE PLLC, SUITE 1404, 5205 LEESBURG PIKE, FALLS CHURCH, VA, 22041, US

(73) Assignee: National Chiao Tung University

(21) Appl. No.: 10/787,211

(22) Filed: Feb. 27, 2004

(51) Int. Cl. G06F 15/00

(52) U.S. Cl. 712/225

(57) ABSTRACT

The present invention is a method for inter-cluster communication that employs register permutation by dynamically mapping the registers to the functional units. Because only the mapping between registers and functional units is changed and no actual data movement occurs, the present invention greatly diminishes the power consumption. Owing to the inter-cluster communication mechanism, a centralized register file can be replaced with small register sub-blocks, where the silicon area is greatly reduced, and the access time and the power consumption are also diminished.

### REFERENCE CITED

1. U.S. Pat. No. 6,629,232
2. U.S. Pat. No. 6,282,585
3. U.S. Pat. No. 6,230,251
4. U.S. Pat. No. 6,269,437
5. U.S. Pat. No. 6,081,880
6. A. Terechko, et al., “Inter-cluster communication models for clustered VLIW processors,” HPCA, 2003.
7. S. Rixner, et al., Register organization for media processing,” HPCA, 2000.
8. J. Zalamea, et al., “Hierarchical clustered register file organization for VLIW processors,” IPDPS, 2003.
9. P. Faraboschi, et al., “Lx: a technology platform for customizable VLIW embedded processing,” ISCA, 2000.
10. The ManArray Story—the Features and Benefits of BOPS' ManArray HDSP Architecture, BOPS, 1999.
11. TMS320C6000 CPU and Instruction Set Reference Guide, Texas Instruments, 2000.
12. S. Sudharsanan, et al., “Image and video processing using MAJC 5200,” ICIP, 2000.

### FIELD OF THE INVENTION

The present invention relates to a method for inter-cluster communications, more particularly, the present invention relates to lessen the interconnection complexity of register files and to reduce the silicon area or power consumption of high-performance digital signal processors.

### DESCRIPTION OF RELATED ART

Modern multimedia and communication systems are apt to require capability of giga-operations per second. IC techniques today are able to easily integrate tens to hundreds of arithmetic units (AUs) into one processor, and when the processor is working on the clock frequency of hundreds of MEGA-Hz to some GIGA-Hz, the above requirement can be easily achieved. But the major design problem is on how to organize the data to flow smoothly among the parallel functional units (FUs) in limited data bandwidth.

Traditional RISC processors separate memory accesses from computations to lessen the complexity of this problem. But the extensibility of the centralized register file in its structure, which is in charge of the data exchange and buffering, is very bad, and has become the bottleneck of high-performance processor designs. Suppose that P ports are needed for N FUs. Then the silicon area, the access time, and the power consumption of a centralized register file containing n registers is to grow in direct ratio of about nP² and n^{1/2}P and nP². n and N are approximately in direct ratio and P is about 3˜4 N, which means the growth rates of area, access time, and power consumption are N³ and N^{3/2} and N³ respectively. So, nowadays, centralized register file designs of a processor that contains 4 to 8 parallel FUs have covered almost a half of the processor core and its access time may be accomplished through more than one pipeline stage. The major key to a successful processor design is on how to design a register file of high efficiency and low power consumption.

Today, most efficient register file designs are by ways of partitioning, which means to partition the said centralized register file into several blocks to reduce the overall complexity. There are two ways for partitioning a register file:

1. Clustering

FUs are partitioned into several clusters, where the FUs in each cluster are to access the registers in the belonging cluster and the data exchanges between clusters are accomplished by extra interconnection network. Each cluster of symmetric partitioning usually has complete FUs, which is able to accomplish a given task independently, so that the data exchange is not frequent. Therefore, the inter-cluster communication is minimal. On the contrary, non-symmetric clusters need extensive data exchanges. For instance, the distributed register file (as shown in FIG. 5) is an extreme non-symmetric partitioning example, where each FU has its own registers. It has a crossbar router to store the computed results to the registers of the FUs that need the results to complete the computing process.

Hierarchical register file is a very special case from non-symmetric partitioning (as shown in FIG. 6), which divides the load/store units and the arithmetic units into two clusters. The registers of the load/store cluster can be regarded as an additional memory hierarchy, where the maintenance and the update of its content are controlled and coordinated by processor instructions.

Data Exchange Mechanisms Between Clusters:

Different ways of clustering require different data exchange mechanisms, which can be classified as the following three methods:

A. Copy Instructions (as Shown in FIG. 7):

The inter-cluster communication is done by explicit “copy” instructions. It requires some extra ports of the register files in each cluster. One implementation is to use the existing slots for the copy instructions and thus to reuse the existing input (or output) ports of the register files. The drawback is that some FUs lie idle while executing the copy instructions. The other implementation is to use dedicated instruction slots at the cost of additional input and output ports. By the way, the extra slots might significantly increase the program size.

B. Extended Accesses (as Shown in FIG. 8):

The FUs have limited read or write accesses to the register files of other clusters. The register file of each cluster needs to support the corresponding read or, write ports with extra external interconnection network and control.

C. Shared Storage (as Shown in FIG. 9):

Each cluster has access ports connected to a common storage and data are exchanged through this shared storage.

2. Banking

The above techniques with FU clustering offer respective temporary registers for different computing clusters and use extra interconnection network for data exchange between the clusters. Yet this technique is by using the way how physical ports and logical ports are mapped to reduce the complexity of the register file, where each FU is able to access every register directly. For example, a centralized register file (i.e. requires P=3N) can be divided into N banks, and each bank has only 3 ports. It needs hardware stalls or software techniques to resolve the access conflicts.

The above methods all need extra ports and interconnection network to exchange data between clusters and they consume large silicon area and significant power. In addition, most of the above methods require redundant data movements, which waste more time and power.

### BRIEF SUMMARY OF THE INVENTION

The present invention divides a centralized register file into local and global registers. Global registers are to act as the communication mechanism between each cluster by way of permutation to eliminate the extra ports for inter-cluster communications. It is able to move data by permutation of the registers.

Another purpose of the present invention is to use it in a structure like high-performance DSP, which needs high data bandwidth so that the data moving between registers are greatly reduced to diminish power consumption. Moreover, the present invention is able to properly partition the register file, so as to reduce the silicon area and the access time.

To achieve the above goals, the present invention describes a method for the inter-cluster communication that employs register permutation, where the clusters exchange data by mapping the interconnection ports of the said global registers dynamically to the clusters via permutation. Each register block can be assigned only exclusively to a cluster, and thus it requires access ports for a single cluster. Because the data exchange is done by changing the port mapping only and it has nothing to do with the actual data movements, an inter-cluster communication mechanism with high bandwidth and low power consumption is achieved.

### BRIEF DESCRIPTION OF THE DRAWINGS

The present invention will be better understood from the following detailed descriptions of the preferred embodiments of the invention, taken in conjunction with the accompanying drawings, in which

FIG. 1 is a diagram illustrating the register file structure of the present invention;

FIG. 2 is a diagram illustrating the ping-pong hierarchical register file according to the present invention;

FIG. 3 is another diagram illustrating a possible embodiment of the present invention;

FIG. 4 is a diagram illustrating the symmetric clustering of functional units of the prior art;

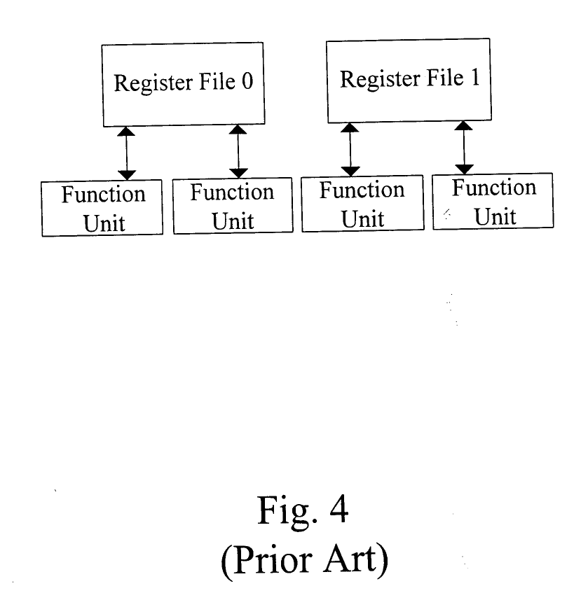

FIG. 5 is a diagram illustrating the distributed register file of the prior art;

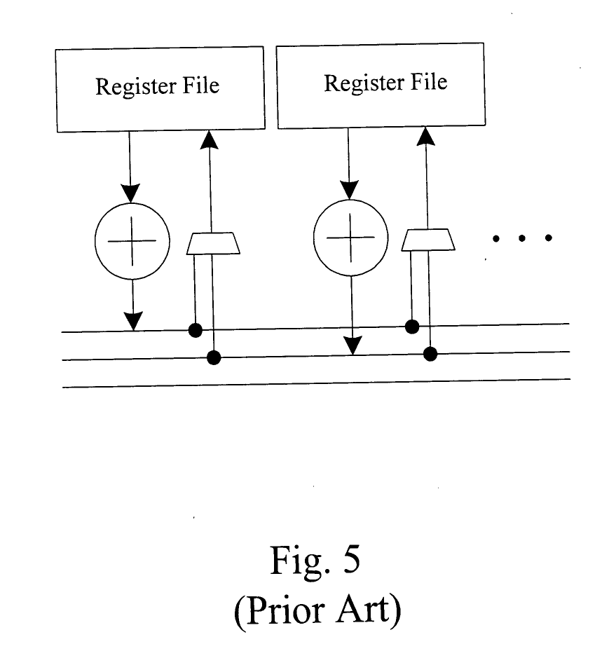

FIG. 6 is a diagram illustrating the hierarchical register file of the prior art;

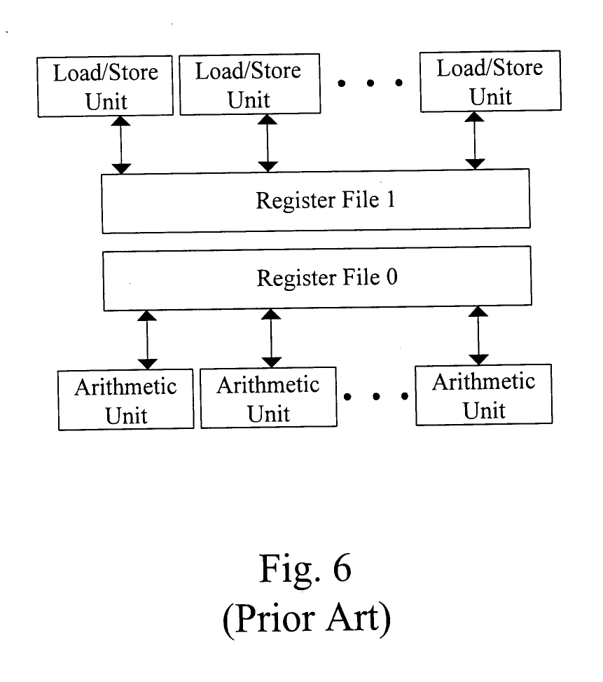

FIG. 7 is a diagram illustrating the inter-cluster communication via copy instructions of the prior art;

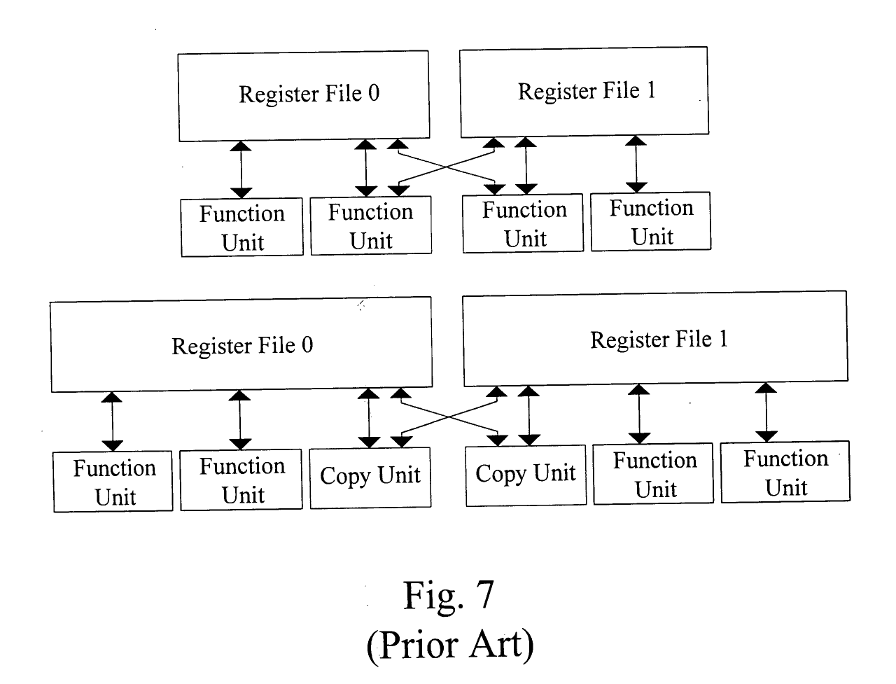

FIG. 8 is a diagram illustrating the inter-cluster communication via extended access of the prior art; and

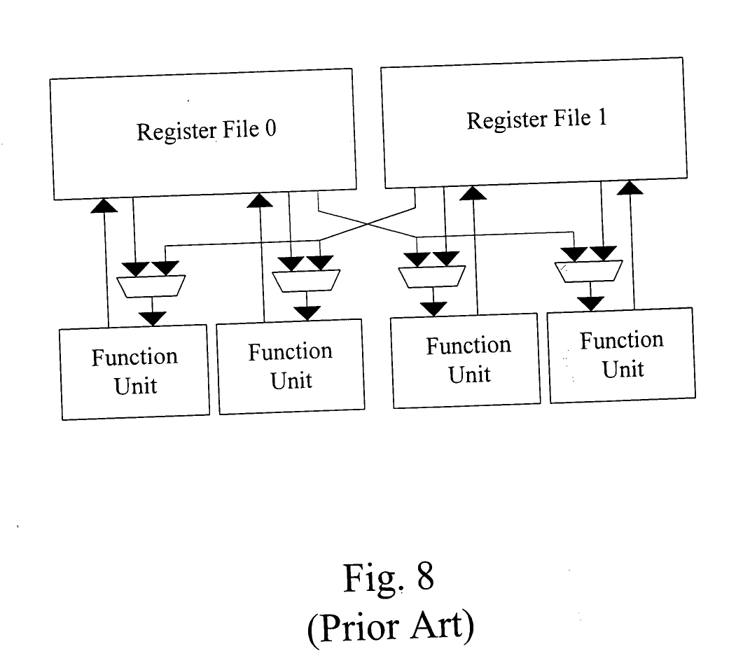

FIG. 9 is a diagram illustrating the inter-cluster communication via share storage of the prior art.

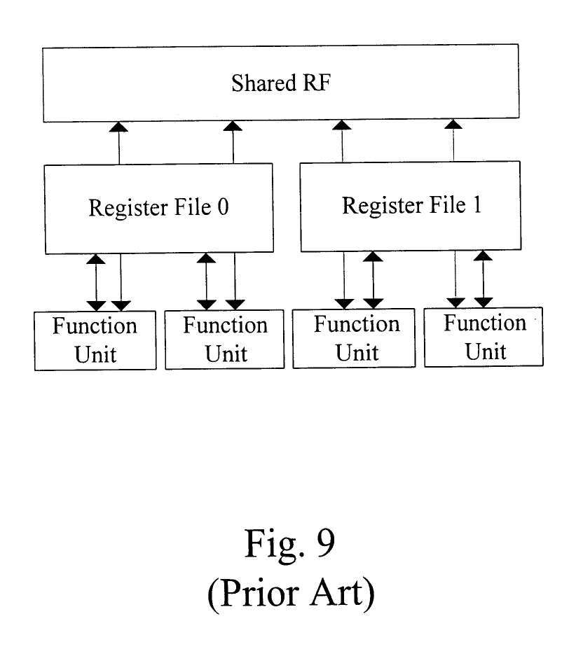

### DESCRIPTION OF THE PREFERRED EMBODIMENTS

The following descriptions of the preferred embodiments are provided to understand the features and the structures of the present invention.

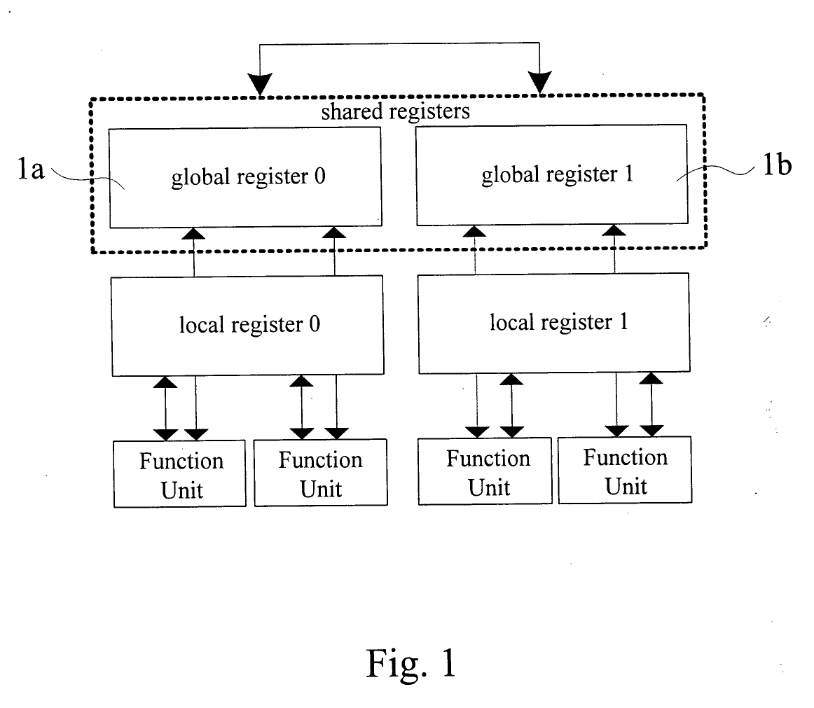

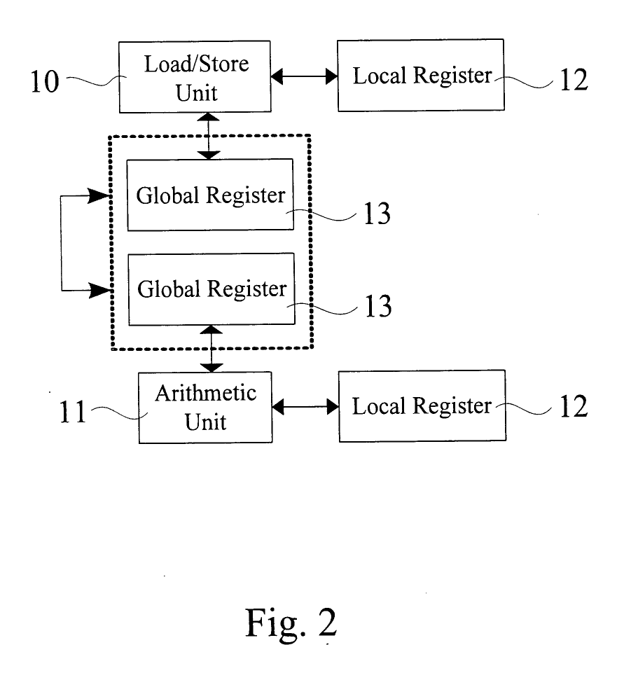

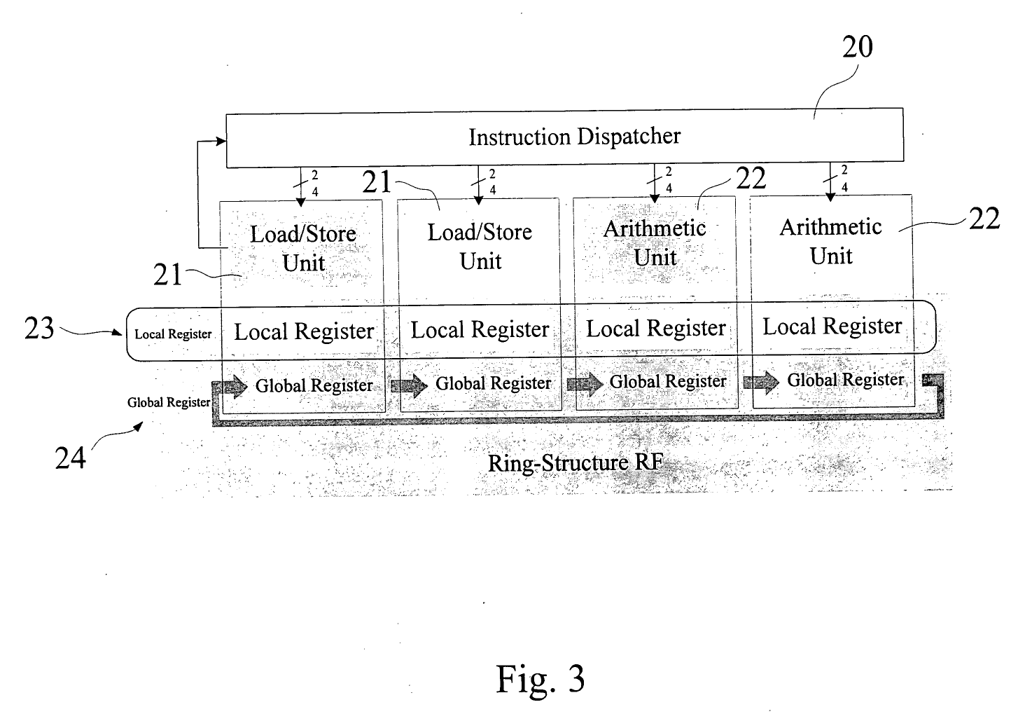

Please refer to FIG. 1, FIG. 2, and FIG. 3, which are a diagrams illustrating the register file structure of the present invention, the ping-pong hierarchical register file according to the present invention, and another possible embodiment of the present invention. As shown in the above figures, the present invention is a method for inter-cluster communications that employs register permutation, which can be applied on any number of clusters. The said clusters have registers partitioned into a local file and a global file. The clusters exchange the data by permuting their respective global register files, which is done by dynamically changing the port mapping between the global register files and the FUs. Neither the size of the said partitions nor the number of connection ports is limited and the mapping between FU and global register files is done by external routing. The said routing can be a cross-bar router or some other interconnection networks. The said permutable global registers can be regarded as shared storage of the said clusters (as shown in FIG. 1), which are divided into plurality of banks 1a 1b. The data exchange between the said clusters is done by switching the said register banks, and has nothing to do with actual data movements. This technique works like register banking, where the physical ports and the logical ports are dynamically mapped to reduce the complexity of the centralized register file. Each FU is able to exclusively access every global register directly. By doing so, data exchange mechanism of high bandwidth is built up, which also greatly reduces the silicon area, the access time, and the power consumption.

The followings are two examples of the hardware embodiments:

( ) 2-Way VLIW Digital Signal Processor (DSP):

As shown in FIG. 2, the embodiment is carried out on a 2-way VLIW DSP, where the load/store (L/S) unit and the arithmetic unit (AU) have respective local registers 12 and global registers 13. The permutation of global registers (R0˜R15) for inter-cluster communication works as a ping-pong buffer for the two clusters. Here the extra hardware needed is only a switch for each cluster to select the appropriate global register file.

( ) 4-Way VLIW DSP

As shown in FIG. 3, the embodiment is carried out on a 4-way VLIW DSP with an additional L/S unit and AU. The deployed ring structure register file is composed of 8 sub-blocks. Each L/S unit or AU is collocated with a set of local registers 23 (R0˜R7) and global registers 24 (R8˜R15). An offset (0˜3) is assigned for dynamic port mapping as the amount of rightward deviation of the global registers 24. If the said amount of deviation is 0, each global register file 24 is mapped to its original FU. If the said amount is 1, the connection of the global register file 24 is deviated rightward by one FU, and so forth. The following is an example program for a 64-tap FIR filter. Two independent clusters can be easily recognized, where the ring-structure register file comprises two sets of ping-pong hierarchical register files. Each one is identical to that of the previous 2-way VLIW DSP example

### EXAMPLE

### 64-Tap Finite Impulse Response (FIR) Filter

Syntax: #, ring offset, instr0, instr1, instr2, instr3 (m [symbol] halfword addressed)

| | | | |
|---|---|---|---|
| i0 0; MOV r0,COEF; | MOV r0,COEF; | MOV r0,0; | MOV r0,0; |
| i1 0; MOV r1,X; | MOV r1,X+1; | NOP; | NOP; |
| i2 0; MOV r2,Y; | MOV r2,Y+2; | NOP; | NOP; |

// assume halfword (16-bit) input & word (32bit) output

i3 RPT 512,8; // 2 outputs per iteration & total 1024 outputs

| | | | |
|---|---|---|---|
| i4 0; LW_D r8,r9,(r0)+2; | LW_D r8,r9,(r0)+2; | MOV r1,0; | MOV r1,0; |

i5 RPT 15,2; // loop kernel: 60 MAC_V, including 120 multiplication (2 out♯put

| | | | |
|---|---|---|---|
| i6 2; LW_D r8,r9,(r0)+2; | LW_D r8,r9,(r0)+2; | MAC_V r0,r8,r9; | MAC_V r0,r |
| i7 0; LW_D r8,r9,(r0)+2; | LW_D r8,r9,(r0)+2; | MAC_V r0,r8,r9; | MAC_V r0,r |
| i8 2; LW_D r8,r9,(r0)+2; | LW_D r8,r9,(r0)+2; | MAC_V r0,r8,r9; | MAC_V r0,r |
| i9 0; MOV r0,COEF; | MOV r0,COEF; | MAC_V r0,r8,r9; | MAC_V r0,r |
| i10 0; ADDI r1,r1,−60; | ADDI r1,r1,−60; | ADD r8,r0,r1; | ADD r8,r0, |
| i11 2; SW (r2)+4,r8; | SW (r2)+4,r8; | MOV r0,0; | MOV r0,0; |

Remarks:

35 instruction cycles for 2 output; i.e. 17.5 cycle/output [symbol] 66 taps/cycle SIMD MAC: MAC_V r0, r8, r9; r0=r0+r8.Hi*r9.Hi & r1=r1+r8.Lo*r9.Lo

This is an example of a 64-tap FIR filter, which generates 1024 results. The memory is half-word addressing, where the inputs and the outputs are stored as 16-bit fractional and 32-bit fixed-point numbers respectively. The inner loop (i7,i8) loads 4 16-bit inputs and 4 16-bit constants to 2 32-bit r8 registers and 2 32-bit r9 registers. The L/S units update the address registers r0, r1, and the AUs execute SIMD MAC operations simultaneously. After multiplying and accumulating 32 16-bit items with 40-bit accumulators, r0 and r1 are summed up and stored to the ring (global) register r8. In the end, r8 is stored to the memory through LS.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

1. A method for inter-cluster communication that employs register permutation, wherein the clustered functional units have some global registers, and the said clusters exchange data by permuting the said global registers of each cluster.

2. The method for inter-cluster communication that employs register permutation according to claim 1, wherein the register permutation is done by dynamically changing the port mapping between the global registers and the functional units.

3. The method for inter-cluster communication that employs register permutation according to claim 2, wherein the said port mapping is done by a crossbar router or by,other routing structures.

4. The method for inter-cluster communication that employs register permutation according to claim 1, wherein neither the size of the said partitioned register files nor the number of the said ports is limited.

5. The method for inter-cluster communication that employs register permutation according to claim 1, further comprising any number of cluster structures.
